(19) United States
(12) Patent Application Publication
(10) Pub. No.: US 2007/0249750 A1
(43) Pub. Date: Oct. 25, 2007

(54) Two-part photocurable ink composition set and ink jet recording method, ink jet recording apparatus, and print using the same

(75) Inventors: Takashi Oyanagi, Shiojiri-shi (JP); Keitaro Nakano, Matsumoto-shi (JP)

Correspondence Address: LADAS & PARRY, 26 West 61st Street, New York, NY, 10023, US

(73) Assignee: SEIKO EPSON CORPORATION

(21) Appl. No.: 11/789,569

(22) Filed: Apr. 25, 2007

(30) Foreign Application Priority Data
Apr. 25, 2006 (JP) 2006-120282
Jul. 24, 2006 (JP) 2006-201364
Apr. 20, 2007 (JP) 2007-111349

(51) Int. Cl. C08F 290/14

(52) U.S. Cl. 522/84

(57) ABSTRACT

A two-part photocurable ink composition set includes an ink composition A containing at least a photoradical polymerization initiator and a radically polymerizable compound and not containing a colorant, and an ink composition B containing at least a colorant and a radically polymerizable compound and not containing a photoradical polymerization initiator.

### BACKGROUND

1. Technical Field

The present invention relates to a photocurable ink composition which is cured by light, and particularly relates to a two-part photocurable ink composition set having excellent curability and preservation stability.

2. Related Art

An ink jet recording method is a method of printing by causing droplets of an ink composition to fly and adhere to a recording medium such as paper. The ink jet recording method is characterized by being capable of printing high-quality images with high resolution at a high speed. The ink composition used in the ink jet recording method generally contains an aqueous solvent as a main component and a coloring component and a wetting agent for preventing clogging, such as glycerin.

On the other hand, in printing on a recording medium such as a type of paper into which an aqueous ink composition hardly penetrates, e.g., coated paper or printed book paper, or cloth, or a recording medium into which an aqueous ink composition does not penetrate, such as a plate or a film produced from a plastic material, e.g., a resin such as phenol, melamine, vinyl chloride, acryl, or polycarbonate, the ink composition is desired to contain a component which enables stable fixing of a colorant to the recording medium.

For such a requirement, a photocurable ink jet ink containing a colorant, a photocuring agent (radically polymerizable compound), and a (photoradical) polymerization initiator is disclosed (refer to, for example, U.S. Pat. No. 5,623,001). It is disclosed that the ink prevents ink blurring in a recording medium and improves image quality.

These photocurable ink jet inks have recently been used for manufacturing color filters, printing on printed circuit boards, printing on plastic cards, vinyl sheets, and plastic products, printing on large advertising displays and outdoor/indoor advertisement, and printing of barcodes and dates.

Japanese Unexamined Patent Application Publication No. 2004-99796 discloses a technique using a dendritic polymer, i.e., a dendrimer, for providing a photocurable ink jet ink having high preservation stability and safety, requiring little energy for curing and fixing, and forming images with excellent chemical resistance, mechanical strength, and adhesiveness to a recording medium. Since a dendrimer has a molecular structure in which functional groups are closely introduced at a high density on the surface as compared with general linear polymers, the dendrimer is expected as a functional polymer nano material. In addition, the dendrimer has low viscosity as compared with linear polymer compounds.

Photocurable ink jet inks frequently cause the problem of preservation stability, i.e., the problem of increasing viscosity and gelating the inks during the period of storage. The problem is due to the chemical reactivity imparted to the inks and is thus a fundamental problem. It is self-evident that substances with higher curing reactivity have lower preservation stability. Therefore, when a large amount of a thermal radical polymerization inhibitor for inhibiting dark reaction of preservation stability is added to an ink composition, polymerization reaction in curing reaction is inhibited to cause difficulty in forming good images.

In particular, when a dendritic polymer, i.e., a dendrimer or a hyperbranched polymer, is used as a radically polymerizable compound for a photocurable ink composition, the problem of preservation stability becomes more significant as compared with general monomer components because of the molecular structure in which polymerizable functional groups are concentrated at a high density on the outermost surface. However, when polymerizable functional groups are not introduced in the outermost surface, phase separation or bleed out occurs after curing reaction, thereby decreasing film strength.

When a dendrimer is used as a radically polymerizable compound in an ink composition, the usable amount of the dendrimer is only about 5% by weight or less because the dendrimer has higher viscosity than that of a general monomer component. For example, in an example of Japanese Unexamined Patent Application Publication No. 2004-99796, only 3% by mass of a dendrimer was used. Such an adding amount of the dendrimer does not exhibit the effect of significantly improving curability.

Further, in an example disclosed in Japanese Unexamined Patent Application Publication No. 2004-99796, the structure of the dendrimer was not sufficiently controlled, and thus the ink viscosity at 25° C. was 30 mPa·s or more in spite of the addition of only 3% by mass of dendrimer to the ink composition. Therefore, printing is difficult and defective ejection often occurs unless an ink head and an ink composition are heated to decrease the viscosity to 10 mPa·s or less, which is the viscosity of usual ink jet ink. When an ink head and an ink composition are heated to decrease the viscosity during use, inevitably, the reliability of ink is decreased, and a constituent member of a printing apparatus is deteriorated due to the progress of thermal polymerization reaction.

In order to decrease viscosity, a low-viscosity diluent, i.e., an organic solvent not containing a polymerizable functional group or water, may be added. However, the addition of a component not involved in curing reaction is undesirable because process loading is increased due to the need for drying by heating or air blowing as a pre-treatment before curing reaction and the need for a specific treatment of providing an absorption layer on a recording medium.

In this case, if curing reaction is effected under a condition in which drying is insufficient, a remaining solvent or water is foamed by polymerization heat or pushed out from a cured product to bleed out and remain on a surface of a cured film, thereby causing tackiness.

### SUMMARY

An advantage of some aspects of the invention is that the invention provides a two-part photocurable ink composition set having excellent image curing property and preservation stability.

As a result of repeated intensive research, the object was achieved using the following constitution, leading to the completion of the invention.

The invention is as follows:

(1) A two-part photocurable ink composition set including an ink composition A containing at least a photoradical polymerization initiator and a radically polymerizable compound and not containing a colorant and an ink composition B containing at least a colorant and a radically polymerizable compound and not containing a photoradical polymerization initiator.

(2) The two-part photocurable ink composition set described above in (1), wherein the ink composition A and the ink composition B do not contain water.

(3) The two-part photocurable ink composition set described above in (1) or (2), wherein an ethylene glycol monoallyl ether and/or a N-vinyl compound is contained as the radically polymerizable compound of the ink composition A and/or the ink composition B.

(4) The two-part photocurable ink composition set described above in (3), wherein the amount of the ethylene glycol monoallyl ether and/or the N-vinyl compound contained in the ink composition A and/or the ink composition B is in the range of 20% by weight to 80% by weight.

(5) The two-part photocurable ink composition set described above in (3) or (4), wherein the N-vinyl compound is N-vinyl formamide.

(6) The two-part photocurable ink composition set described above in any one of (1) to (5), wherein a dendritic polymer is contained as the radically polymerizable compound in the ink composition A and/or the ink composition B.

(7) The two-part photocurable ink composition set described above in (6), wherein the dendritic polymer is a dendrimer and/or a hyperbranched polymer.

(8) The two-part photocurable ink composition set described above in (6) or (7), wherein the content of the dendritic polymer is 3 to 30% by weight.

(9) The two-part photocurable ink composition set described above in any one of (1) or (8), wherein the ink composition A and/or the ink composition B contains a surfactant.

(10) The two-part photocurable ink composition set described above in (9), wherein polyether-modified polydimethylsiloxane or polyester-modified polydimethylsiloxane is used as the surfactant.

(11) The two-part photocurable ink composition set described above in any one of (1) to (10), wherein the ink composition A and/or the ink composition B contains a polymerization accelerator.

(12) The two-part photocurable ink composition set described above in (11), wherein any one of an amine compound, thioxanthone, and polymerizable fine particles is contained as the polymerization accelerator.

(13) The two-part photocurable ink composition set described above in any one of (1) to (12), wherein the photoradical polymerization initiator contained in the ink composition A is any one of α-aminoketone, α-hydroxyketone, and acylphosphine oxide.

(14) The two-part photocurable ink composition set described above in (13), wherein a mixture of any two or more of α-aminoketone, α-hydroxyketone, and acylphosphine oxide is used as the photoradical polymerization initiator.

(15) The two-part photocurable ink composition set described above in any one of (1) to (14), wherein the ink composition A and the ink composition B contain a thermal radical polymerization inhibitor.

(16) The two-part photocurable ink composition set described above in (15), wherein the thermal radical polymerization inhibitor is a HALS compound.

(17) The two-part photocurable ink composition set described above in any one of (1) to (16), wherein the colorant contained in the ink composition B is a pigment.

(18) An ink jet recording method using the two-part photocurable ink composition set described above in any one of (1) to (17).

(19) An ink jet recording apparatus using the ink jet recording method described above in (18).

(20) A print including an image at least a portion of which is formed using the ink jet recording method described in (18) and/or the ink jet recording apparatus described in (19).

### DESCRIPTION OF EXEMPLARY EMBODIMENTS

A two-part photocurable ink composition set according to an embodiment of the invention will be described in detail below.

A two-part photocurable ink composition set according to an embodiment of the invention includes an ink composition A containing at least a photoradical polymerization initiator and a radically polymerizable compound and not containing a colorant and an ink composition B containing at least a colorant and a radically polymerizable compound and not containing a photoradical polymerization initiator. The two-part photocurable ink composition set preferably does not contain water.

The photoradical polymerization initiator used in the ink composition A is not particularly limited, but α-aminoketone, α-hydroxyketone, and acylphosphine oxide are preferred. Examples of such compounds include α-hydroxyalkylphenone, α-aminoalkylphenone, monoacylphosphine oxide, and bisacylphosphine oxide.

Other usable examples include photoradical polymerization initiators available as the trade names of Irgacure 127, 184, 369, 379, 1700, 1800, 1850, 1870, and 819, Darocur 1173, and TPO (manufactured by Ciba Specialty Chemicals Co., Ltd.).

As the radically polymerizable compound used in the ink composition A and/or the ink composition B, an ethylene glycol monoallyl ether and/or a N-vinyl compound, preferably N-vinyl formamide, is used.

The ethylene glycol monoallyl ether and/or N-vinyl formamide is a monofunctional radically polymerizable monomer, has a low tendency to produce undesirable polymerization by dark reaction during preservation, and is thus preferably used.

When the amount of the ethylene glycol monoallyl ether and/or N-vinyl formamide added is less than 20% by weight, there occur the problems with viscosity, dispersion stability, and preservation stability of the ink composition. When the amount exceeds 80% by weight, the curability of the two-part photocurable ink composition and film strength may become insufficient. The amount is more preferably 20% by weight to 70% by weight.

The ink composition A and/or B may contain a dendritic polymer as the radically polymerizable compound. Dendritic polymers are roughly classified into the following six structures:

I dendrimer

II linear dendritic polymer

III dendrigraft polymer

IV hyperbranched polymer

V star hyperbranched polymer

VI hypergraft polymer

Among these structures, I to III have a degree of branching (DB) of 1 and a defect-free structure, while IV to VI have a random branched structure which may contain defects. In particular, the dendrimer is capable of concentrating reactive functional groups at a high density on the outermost surface thereof and is thus highly expected as a functional polymer material. The hyperbranched polymer is also capable of introducing many reactive functional groups in the outermost surface, but not so much as the dendrimer, and is excellent in curability.

Unlike in general linear polymers and branched polymers, in the dendritic polymers, a branched structure is three-dimensionally repeated to form a highly branched structure. Therefore, the viscosity may be suppressed to a low level as compared with linear polymers having the same molecular weight.

As the synthesis method for the dendrimer used in the invention, a divergent method of synthesizing the dendrimer from the center to the outside or a convergent method of synthesizing the dendrimer from the outside to the center may be used.

The dendrimer or hyperbranched polymer used in the invention is solid at room temperature and has a number-average molecular weight preferably in the range of 1,000 to 100,000 and more preferably in the range of 2,000 to 50,000. When the molecular weight is lower than the above range, a fixed image becomes brittle, while when the molecular weight is over the range, the viscosity of the ink is excessively high even when the adding amount is decreased, thereby making the ink unpractical from the viewpoint of ejection properties.

The dendrimer and/or hyperbranched polymer used in the invention is preferably a dendrimer and/or hyperbranched polymer having radically polymerizable functional groups in the outermost surface. With a radically polymerizable structure in the outermost surface, polymerization reaction rapidly proceeds.

Examples of a polymer having a dendrimer structure include amide-amine dendrimers disclosed in U.S. Pat. Nos. 4,507,466, 4,558,120, 4,568,737, 4,587,329, 4,631,337, and 4,694,064; and phenyl ether dendrimers disclosed in U.S. Pat. No. 5,041,516 and Journal of American Chemistry Vol. 112 (1990, pp. 7638-7647). As an amide-amine dendrimer, a dendrimer containing a terminal amino group and a methyl carboxylate group is commercially available as “Starburst™ (PAMAM)” from Aldrich Inc. The terminal amino group of the amide-amine dendrimer may be reacted with any one of various acrylic acid derivatives and methacrylic acid derivatives to synthesize an amide-amine dendrimer having a corresponding end. Such an amide-amine dendrimer may be used.

Examples of acrylic acid derivatives and methacrylic acid derivatives include, but are not limited to, acrylic or methacrylic acid alkyl esters such as methyl, ethyl, n-butyl, tert-butyl, cyclohexyl, palmityl, and stearyl esters; and acrylic acid or methacrylic acid alkyl amides such as acrylic acid amide and isopropylamide.

In addition, various phenyl ether dendrimers are described in Journal of American Chemistry Vo. 112 (1990, pp. 7638-7647)). It is also described that for example, 3,5-dihydroxybenzyl alcohol is reacted with 3,5-diphenoxybenzyl bromide to synthesize second-generation benzyl alcohol, a OH group of the benzyl alcohol is converted to Br using CBr₄ and triphenylphosphine and then the benzyl alcohol is reacted with 3,5-dihydroxybenzyl alcohol to synthesize next-generation benzyl alcohol after, and these reactions are repeated to synthesize a desired dendrimer. In a phenyl ether dendrimer, a terminal benzyl ether bond may be substituted by any one of groups with various chemical structures. For example, in synthesis of a dendrimer described in Journal of American Chemistry Vo. 112 (1990, pp. 7638-7647)), various alkyl halides may be used in place of the benzyl bromide to obtain phenyl ether dendrimers each having a terminal structure containing a corresponding alkyl group. Further, polyamine dendrimers disclosed in Macromol. Symp. 77, 21 (1994) and derivatives prepared by modifying the terminal groups of the polyamine dendrimers may be used.

As the hyperbranched polymer, for example, hyperbranched polyethylene glycol may be used. The hyperbranched polymer is obtained by synthesizing a target polymer in one step using a monomer having, in its molecule, two or more reaction points corresponding to a branch portion and only one different reaction point corresponding to a link portion (Macromolecules, Vol. 29 (1996), pp. 3831-3838). An example of a monomer for the hyperbranched polymer is a 3,5-dihydroxybenzoic acid derivative. In an example of production of a hyperbranched polymer, methyl 3,5-bis((8′-hyroxy-3′,6′-dioxaoctyl)oxy)benzoate which is a hydrolyzate of methyl 3,5-bis((8′-(tert-butyldiphenylsiloxy)-3′,6′-dioxaoctyl)oxy)benzoate prepared from 1-bromo-8-(tert-butyldiphenylsiloxy)-3,6-dioxaoctane and methyl 3,5-dihydroxybenzoate is heated together with dibutyltin diacetate in a nitrogen atmosphere to synthesize a hyperbranched polymer, poly[bis(triethylene glycol)benzoate].

When 3,5-dihydroxybenzoic acid is used, a terminal group of the resulting hyperbranched polymer is a hydroxyl group. Therefore, it may be possible to synthesize hyperbranched polymers having various terminal groups using appropriate alkyl halides for the hydroxyl group.

The properties of a monodisperse polymer having a dendrimer structure or a hyperbranched polymer depend on the chemical structure of the main chain and the chemical structure of the terminal group. In particular, the properties greatly depend on the terminal group and the type a substituent in the chemical structure. When a polymerizable group is present as a terminal group, a gelation effect after photoreaction is advantageously large because of its reactivity. A dendrimer having a polymerizable group is produced by chemically modifying, with a polymerizable group-containing compound, a terminal having a basic atom group such as an amino group, a substituted amino group, or a hydroxyl group.

For example, a polymerizable group-containing dendrimer is synthesized by, for example, adding an isocyanate group-containing vinyl compound to a polyfunctional compound which is prepared by Michael addition of an active hydrogen-containing (meth)acrylate compound to an amino dendrimer. A dendrimer having a polymerizable group at an end is obtained by, for example, reacting an amino dendrimer with (meth)acryl chloride. As such a vinyl compound providing a polymerizable group, a compound having a radically polymerizable ethylenic unsaturated bond may be used. Examples thereof include unsaturated carboxylic acids such as acrylic acid, methacrylc acid, itaconic acid, crotonic acid, isocrotonic acid, and maleic acid, and salts thereof; and compounds having various radically polymerizable ethylenic unsaturated bonds which will be described below.

The dendrimer or the hyperbranched polymer may be used singly or may be combined with another dendrimer or hyperbranched polymer.

In the ink composition B of the two-part photocurable ink composition set, the amount of the dendritic polymer added is preferably in the range of about 3% by weight to 30% by weight because the suitability as a two-part photocurable ink composition set is maintained. The amount is more preferably in the range of about 5% by weight to 25% by weight. When the amount of the dendritic polymer added is less than 3% by weight, curability of the two-part photocurable ink composition set is insufficient, while when the amount exceeds 30% by weight, the problems of viscosity, dispersion stability, and preservation stability of the ink composition may occur.

The ink composition A and the ink composition B of the two-part photocurable ink composition set may each contain another radically polymerizable compound.

Examples of another radically polymerizable compound include, but are not limited to, monomers.

The term “monomer” represents a molecule which forms a structural unit of a polymer basic structure. The monomer used in the present invention is referred to as a “photopolymerizable monomer”, and any one of a monofunctional monomer, a difunctional monomer, and a polyfunctional monomer may be used. These monomers preferably have a PII (Primary Irritation Index) value of 2 or less.

Usable examples of a monofunctional monomer, a difunctional monomer, and a polyfunctional monomer which have a PII value of 2 or less are shown in Table 1 below.

TABLE 1

| | Viscosity | |
|---|---|---|
| Name of material | (mPa · s) | PII |
| Monofunctional monomer | | |
| (2-Methyl-2-ethyl-1,3-dioxolan-4-yl)methyl | 5.1 | 1.3 |
| acrylate (MEDOL-10, Osaka Organic Chemical | | |
| Industry Ltd.) | | |
| (2-Methyl-2-isobutyl-1,3-dioxolan-4-yl)methyl | 5.3 | 1.0 |
| acrylate (MIBDOL-10, Osaka Organic Chemical | | |
| Industry Ltd.) | | |
| Phenoxyethyl acrylate (Viscoat#192, Osaka Organic | 3.3 | 1.7 |
| Chemical Industry Ltd.) | | |
| Isobonyl acrylate (IBXA, Osaka Organic Chemical | 2.6 | 0.6 |
| Industry Ltd.) | | |
| Methoxydiethylene glycol monoacrylate (Blenmer | 2 | 0.7 |
| PME-100, NOF Corporation) | | |
| Acryloyl morpholine (ACMO, Kohjin Co., Ltd.) | 12 | 0.5 |
| Difunctional monomer | | |
| Ethylene glycol dimethacrylate (Light Ester EG, | 3 | 0.6 |
| Kyoeisha Chemical Co., Ltd) | | |
| Diethylene glycol dimethacrylate (Light Ester 2EG, | 5 | 0.5 |
| Kyoeisha Chemical Co., Ltd) | | |
| Tripropylene glycol diacrylate (Aronix M-220, | 12 | 1.6 |
| Toagosei Co., Ltd.) | | |
| 1,9-Nonanediol diacrylate (Viscoat#260, Osaka | 21 | 2.0 |
| Organic Chemical Industry Ltd.) | | |
| Polyethylene glycol #400 diacrylate (NK Ester | 58 | 0.4 |
| A400, Shin-Nakamura Chemical Co., Ltd.) | | |
| Tetraethylene glycol dimethacrylate (NK Ester 4G, | 14 | 0.5 |
| Shin-Nakamura Chemical Co., Ltd.) | | |
| 1,6-Hexanediol dimethacrylate (NK Ester HD-N, | 6 | 0.5 |
| Shin-Nakamura Chemical Co., Ltd.) | | |
| Neopentyl glycol dimethacrylate (NK Ester NPG, | 7 | 0.0 |
| Shin-Nakamura Chemical Co., Ltd.) | | |
| 2-Hydroxy-1,3-dimethacryloxypropane (NK Ester 701, | 37 | 0.6 |
| Shin-Nakamura Chemical Co., Ltd.) | | |
| 1,4-Butanediol dimethacrylate (BD, Shin-Nakamura | 7 | 2.0 |
| Chemical Co., Ltd.) | | |
| Polyfunctional monomer | | |
| Trimethylolpropane trimethacrylate (NK Ester TMPT, | 42 | 0.8 |
| Shin-Nakamura Chemical Co., Ltd.) | | |
| Trimethylolpropane modified triacrylate | 55 | 1.5 |
| (Viscoat#360, Osaka Organic Chemical Industry | | |
| Ltd.) | | |
| Trimethylolpropane PO modified triacrylate (New | 60 | 0.1 |
| Frontier TMP-3P, Dai-Ichi Kogyo Seiyaku Co., Ltd.) | | |
| Glycerin PO modified triacrylate (Viscoat#GPT, | 75 | 0.8 |
| Osaka Organic Chemical Industry Ltd.) | | |

### In the table, the viscosity is a value measured at 25° C.

As the radically polymerizable compound in the two-part photocurable ink composition set, an oligomer may be contained instead of the monomer.

When the ink composition A containing the photoradical polymerization initiator contains a monofunctional radically polymerizable monomer as the radically polymerizable compound, there is the low possibility that the radically polymerizable compound reacts with the photoradical polymerization initiator to produce undesirable polymerization during preservation. As the monofunctional monomer, N-vinyl formamide and ethylene glycol monoallyl ether are preferred.

The ink composition A and/or the ink composition B may further contain a surfactant. For example, as a silicone surfactant, polyester-modified silicone and polyether-modified silicone are preferably used. In particular, polyether-modified polydimethylsiloxane and polyester-modified polydimethylsiloxane are preferred. Examples of such a surfactant include BYK-347, BYK-348, and BYK-UV3500, 3510, 3530, and 3570 (manufactured by BYK-Chemie Japan Co., Ltd.).

The ink composition A or the ink composition B of the two-part photocurable ink composition set may further contain a polymerization accelerator. As the polymerization accelerator is not particularly limited, but at least one of an amine compound, thioxanthone, and polymerizable fine particles is preferably contained. Examples of the polymerization accelerator include aminobenzoate, e.g., Darocur EHA and EDB (manufactured by Ciba Specialty Chemicals Co., Ltd.), thioxanthone, isopropyl thioxanthone dimethyl thioxanthone, diethyl thioxanthone, and polymerizable fine particles having polymerizable functional groups introduced in the surfaces thereof.

Further, the ink composition A or the ink composition B of the two-part photocurable ink composition set preferably contains a thermal radical polymerization inhibitor. In this case, the preservation stability of the ink composition is improved. As the thermal radical polymerization inhibitor, a polymerization inhibitor which is mixed in general polymerizable compositions may be used. Examples of such a polymerization inhibitor include a phenolic antioxidant, a hindered amine photostabilizer, a phosphorus-based antioxidant, hydroquinone monomethyl ether widely used for (meth)acrylic monomers, hydroquinone, tert-butyl catechol, and pyrogallol. Preferably, a HALS compound, e.g., Irgastab UV-10 (manufactured by Ciba Specialty Chemicals Co., Ltd.), is used.

In the two-part photocurable ink composition set, only the ink composition B contains a colorant. The colorant used is preferably a pigment from the viewpoint of durability of a print.

The pigment used in the present invention is not particularly limited, and an inorganic pigment and an organic pigment may be used.

Usable examples of the inorganic pigment include titanium oxide, iron oxide, and carbon black produced by a known method such as a contact method, a furnace method, or a thermal method. Usable examples of the organic pigment include azo pigments (e.g., azo lake, insoluble azo pigments, condensed azo pigments, and chelate azo pigments); polycyclic pigments (e.g., phthalocyanine pigments, perylene pigments, perinone pigments, anthraquinone pigments, quinacridone pigments, dioxazine pigments, thioindigo pigments, isoindolinone pigments, and quinofuran pigments); dye chelates (e.g., basic dye chelates and acid dye chelates); nitro pigments; nitroso pigments; and aniline black.

Examples of carbon black pigments include C. I. Pigment Black 7; No. 2300, No. 900, MCF88, No. 33, No. 40, No. 45, No. 52, MA7, MA8, MA100, and No. 2200B manufactured by Mitsubishi Chemical Corporation; Raven 5750, 5250, 5000, 3500, 1255, and 700 manufactured by Columbia Chemical Co., Ltd.; Regal 400R, 330R, and 660R, Mogul L and 700, Monarch 800, 880, 900, 1000, 1100, 1300, and 1400 manufactured by Cabot Corporation; and Color Black FW1, FW2, FW2V, FW18, and FW200, Color Black S150, S160, and S170, Printex 35, U, V, and 140U, Special Black 6, 5, 4A, and 4 manufactured by Degussa Inc.

Examples of pigments used for yellow ink include C. I. Pigment Yellow 1, 2, 3, 12, 13, 14, 16, 17, 73, 74, 75, 83, 93, 95, 97, 98, 109, 110, 114, 120, 128, 129, 138, 139, 150, 151, 154, 155, 180, 185, and 213.

Examples of pigments used for magenta ink include C. I. Pigment Red 5, 7, 12, 48 (Ca), 48 (Mn), 57 (Ca), 57:1, 112, 122, 123, 168, 184, 202, and 209, and C. I. Pigment Violet 19.

Examples of pigments used for cyan ink include C. I. Pigment Blue 1, 2, 3, 15:3, 15:4, 60, 16, and 22.

Examples of pigments used for white ink include titanium dioxide, calcium carbonate, calcium sulfate, zinc oxide, barium sulfate, barium carbonate, silica, alumina, kaolin, clay, talc, white clay, aluminum hydroxide, magnesium carbonate, and white hollow resin emulsion. These pigments are preferably used alone or as a mixture of two or more.

Examples of pigments usable for metallic ink include, but are not limited to, metal flakes prepared by forming a composite pigment base having a structure in which a separation resin layer and a metal or metal compound layer are laminated in order on a surface of a sheet-like substrate, separating the metal or metal compound layer from the sheet-like substrate at the interface between the metal or metal compound layer and the separation resin layer, and then grinding the metal or metal compound layer.

The metal or metal compound used for the metal or metal compound layer of the composite pigment base for producing the metal flakes is not particularly limited as long as it has a function such as metallic luster. Examples of the metal or metal compound include elemental metals such as aluminum, silver, gold, nickel, chromium, tin, zinc, indium, titanium, and copper, and metal compounds, alloys, and mixtures thereof. At least one of these metal or metal compounds is used. In order to control the color tone of each color pigment, a plurality of color pigments may be mixed. For example, Pigment Black 7 and Pigment Blue 15:3 may be mixed for changing the color tone of reddish black to bluish black. In addition, a fluorescent brightener may be added.

In a preferred embodiment of the invention, the average particle diameter of the inorganic or organic pigment is preferably in the range of 10 nm to 200 nm and more preferably in the range of about 50 nm to 150 nm. As a metallic pigment, metal flakes having an average thickness of 30 nm to 100 nm, a 50% volume-average particle diameter of 1.0 μm to 4.0 μm, and the maximum particle diameter of 12 μm or less in a particle diameter distribution are preferred.

The amount of the colorant added to the ink composition is preferably in the range of about 0.1% by weight to 25% by weight and more preferably in the range of about 0.5% by weight to 15% by weight.

In a preferred embodiment of the invention, the pigment is used as a pigment dispersion liquid for the ink composition A or the ink composition B, the pigment dispersion liquid being prepared by dispersing the pigment in an aqueous medium using a dispersant or a surfactant. As the dispersant, a dispersant commonly used for preparing pigment dispersion liquids, for example, a polymer dispersant, is preferably used.

When the ink composition contains the colorant, there may be a plurality of ink compositions for each color. For example, when a deep color and a light color in the same series are added to each of the four basic colors of yellow, magenta, cyan, and black, light magenta and deep red are added to magenta, and light cyan, deep blue, and violet are added to cyan. Further, medium colors such as green and orange are added. In addition, gray, light black, matte black as a deep color are added to an achromatic color, black, and cream, ivory are added to an achromatic color, white, and silver, gold, copper, and chrome silver are added as metallic colors.

Furthermore, if required, a leveling agent, a matting agent, and a polyester resin, a polyurethane resin, a vinyl resin, an acrylic resin, a rubber resin, a polyacryl polyol resin, a polyoxyalkylene polyalkylene amine resin, or wax for controlling film physical properties may be added. The ink composition A or the ink composition B may further contain other known public components which are used for two-part photocurable inks, such as a wetting agent, a penetrant, a pH adjuster, a preservative, and a fungicide.

The two-part photocurable ink composition set is subjected to curing reaction by light irradiation after the ink composition A and the ink composition B are mixed. The mixing may be performed before or after printing as long as it is performed before curing reaction. Namely, in the mixing and printing, the ink composition A and the ink composition B may be adhered to the same position on a recording medium, or a mixture of the ink composition A and the ink composition B may be adhered to a recording medium.

An ink jet recording method using the two-part curable ink composition set preferably includes ejecting the ink compositions to a recording medium and then irradiating the ink compositions with ultraviolet rays.

An irradiation light source is not particularly limited, but light at a wavelength of 350 nm to 450 nm is preferred as irradiation light. The ultraviolet exposure is 10 mJ/cm² to 20,000 mJ/cm² and preferably in the range of 50 mJ/cm² to 15,000 mJ/cm². With an ultraviolet exposure within this range, curing reaction is sufficiently effected.

The ultraviolet irradiation may be performed using a metal halide lamp, a xenon lamp, a carbon arc lamp, a chemical lamp, a low-pressure mercury-vapor lamp, or a high-pressure mercury-vapor lamp. For example, a commercial lamp, such as H lamp, D lamp, or V lamp manufactured by Fusion System Corporation, may be used.

The ultraviolet irradiation may be performed by a ultraviolet light emitting semiconductor device such as an ultraviolet light emitting diode (ultraviolet LED) or an ultraviolet light emitting semiconductor laser.

An ink jet recording apparatus using the ink jet recording method may be used for desired recording on a recording medium.

Further, the ink jet recording method and/or the ink jet recording apparatus may be used for forming at least a portion of an image of a print. The material of the print is not particularly limited.

### EXAMPLE

The invention will be described in detail with reference to examples, but the invention is not limited to these examples.

### (Preparation of Each Ink Composition of Photocurable Ink Set)

In the invention, a hyperbranched polymer or a dendrimer was used as a dendritic polymer.

As the hyperbranched polymer, “Viscoat #1000” and “STAR-501” manufactured by Osaka Organic Chemical Industry Ltd. were used. “Viscoat #1000” and “STAR-501” are a hyperbranched polymer in which functional groups are branched from a core of dipentaerythritol. “Viscoat #1000” contained ethylene glycol diacrylate as a diluent monomer and had a viscosity of 273 mPa·s and a number of functional groups of 14 (acryl group). “STAR-501” contained dipentaerythritol hexaacrylate as a diluent monomer and had a viscosity of 210 mPa·s and a number of functional groups of 20 to 99 (acryl group).

Dendrimers 7 and 9 were synthesized as follows:

In a 1 L-volume reactor, 31 g of ethylenediamine, 256 g of dimethyl acrylate, and 300 g of methanol were placed, followed by reaction for 6 hours under stirring at 40° C. in a nitrogen stream. After the completion of the reaction, methanol was distilled off from the resultant mixture using a rotary evaporator, and then the residue was added to a large excess of diethyl ether and purified by reprecipitation operation. Then, 500 g of methanol was added to the resultant reaction product 1 to dissolve the product 1, followed by next reaction.

In a 2 L-volume reactor, the methanol solution containing the reaction product 1 was placed, and 240 g of ethylenediamine was added, followed by reaction for 6 hours under stirring at 27° C. in a nitrogen stream. After the reaction, methanol was distilled off, and the residue was purified by reprecipitation operation by the same method as described above. Then, 1,000 g of methanol was added to the resultant reaction product 2 to dissolve the product 2, followed by next reaction.

In a 5 L-volume reactor, the methanol solution containing the reaction product 2 was placed, and 667 g of dimethyl acrylate was added, followed by reaction for 6 hours under stirring at 40° C. in a nitrogen stream. After the reaction, methanol was distilled off, and the residue was purified by reprecipitation operation by the same method as described above. Then, 2,000 g of methanol was added to the resultant reaction product 3 to dissolve the product 3, followed by next reaction.

In a reactor, the methanol solution containing the reaction product 3 was placed, and 361 g of ethylenediamine was added, followed by reaction for 6 hours under stirring at 27° C. in a nitrogen stream. After the reaction, methanol was distilled off, and the residue was purified by reprecipitation operation by the same method as described above. Then, 2000 g of acetone dehydrated with molecular sieve was added to the resultant reaction product 4 to dissolve the product 4, followed by next reaction.

In a reactor, 1,000 g of the acetone solution containing the reaction product 4 was placed, and 2153 g of Karenz BEI (1,1-Bis(acryloyloxymetyl)ethyl isocyanate, manufactured by Showa Denko K. K.) was added, followed by mixing and stirring in a nitrogen stream. Then, 1 g of DABCO (1,4-Diazabicyclo[2,2,2]octane, manufactured by manufactured by Tokyo Chemical Industry Co., Ltd.) was added, and the resultant mixture was stirred and mixed. After the reaction temperature was increased to 50° C., reaction was performed for 6 hours. After the completion of the reaction, acetone was distilled off with a rotary evaporator, and 6838 g of ethylene glycol monoallyl ether was added to the residue to prepare a 30 wt % ethylene glycol monoallyl ether solution 8 of the dendrimer 7.

In this case, the number of the acryloyl groups arranged in the outermost surface of the dendrimer 7 per molecule was 72.

Further, acetone was distilled off from the acetone solution containing the reaction product 4 with a rotary evaporator, and 6838 g of ethylene glycol monoallyl ether was added to the residue to prepare a 30 wt % ethylene glycol ally ether solution 10 of the dendrimer 9. The dendrimer 9 had no radically polymerizable reactive group in the outermost surface.

A pigment dispersion liquid was prepared by the following method:

First, a monomer, ethylene glycol monoallyl ether (manufactured by Nippon Nyukazai Co., Ltd., referred to as “AG” hereinafter), was added to 15 parts of C. I. Pigment Black 7 (carbon black) used as a colorant and 3.5 parts of Discol N-509 (manufactured by Dainichiseika Color & Chemicals Mfg. Co., Ltd.) used as a dispersant to prepare 100 parts of a mixture, followed by mixing and stirring. The resultant mixture was dispersed for 6 hours together with zirconia beads (diameter 1.5 mm) using a sand mill (manufactured by Yasukawa Seisakusho). Then, the zirconia beads were separated by a separator to prepare a black pigment dispersion liquid.

Similarly, pigment dispersion liquids corresponding to respective colors, i.e., a cyan pigment dispersion liquid (C. I. Pigment Blue 15:3), a magenta pigment dispersion liquid (C. I. Pigment Violet 19), and a yellow pigment dispersion liquid (C. I. Pigment Yellow 155), were prepared.

### (Preparation of Ink Compositions A1 to A14 and Ink Compositions B1 to B14)

Ink compositions A1 to A14 and ink compositions B1 to B14 having the compositions shown in Tables 2 to 5, 7 to 10, 12, 14, and 15 were prepared. Namely, the components shown in the tables were selected from a monomer, a photoradical polymerization initiator, a polymerization accelerator, a surfactant, a thermal radical polymerization inhibitor, and water and were mixed and completely dissolved. Next, when a pigment dispersion liquid was used, the pigment dispersion liquid was gradually added dropwise to the solvent under stirring. After the addition, the mixture was mixed by stirring at room temperature for 1 hour. Then, each of the ink compositions A1 to A14 and the ink compositions B1 to B14 was filtered through a membrane filter of 5 μm to prepare a desired ink composition.

In each of the tables, a numerical value is shown by “% by weight”.

As the thermal radical polymerization inhibitor, Irgastab UV-10 (manufactured by Ciba Specialty Chemicals Co., Ltd.) was used. In addition, ion-exchanged water was used as water.

### (Preservation Stability Test)

Each of the ink compositions A1 to A14 and the ink compositions B1 to B14 of the two-part photocurable ink composition set of the example and an ink composition of a comparative example was allowed to stand in an environment of 60° C. for 7 days, and the initial viscosity (mPa·s) and viscosity (mPa·s) after standing were measured using a rheometer (manufactured by Physica Co., Ltd., MCR-300) to evaluate a rate of change in viscosity on the basis of the following criteria. The results are shown in Tables 6, 11, 13, and 16.

AAA: A rate of change between the initial viscosity and viscosity after standing was ±2.5% or less.

AA: A rate of change between the initial viscosity and viscosity after standing was ±5.0% or less.

A: A rate of change between the initial viscosity and viscosity after standing was ±10% or less.

B: A rate of change between the initial viscosity and viscosity after standing was more than ±10%.

### (Curability Test 1)

The ink composition A and the ink composition B of the two-part photocurable ink composition set prepared as described above were added dropwise onto a glass substrate and then mixed to prepare a sample. By using the sample, curability of the two-part photocurable ink composition set was evaluated according to the procedures below. An ultraviolet irradiation apparatus was formed using ultraviolet light emitting diode NICHIAi-LED “NCCU033” with a peak wavelength of 365 nm and ultraviolet light emitting diode NICHIA “NCCU001” with a peak wavelength of 380 nm (both manufactured by Nichia Corporation). The irradiation conditions were controlled so that the irradiation intensity on an irradiation surface at each of the wavelengths of 365 nm and 380 nm was 20 mW/cm², i.e., a total intensity was 40 mW/cm². The sample was irradiated with ultraviolet rays for 5 seconds so that the integrated quantity of light per ultraviolet irradiation was 200 mJ/cm². Then, the curability of the two-part photocurable ink composition set (simply shown as “Ink” in the tables) was evaluated on the basis of the criteria below. The results are shown in Tables 6, 11, 13, and 16.

A: Sufficient curability was exhibited by one time of ultraviolet irradiation and thus ink was usable.

B: Sufficient curability was exhibited by two times of ultraviolet irradiation and thus ink was usable.

C: Sufficient curability was not exhibited even by several times of ultraviolet irradiation and thus ink was unusable.

TABLE 2

Example 1

| | Ink Composition A6 | Ink Composition B10 |
|---|---|---|
| | (%) | (%) |
| NVF | 22.0 | — |
| AG | — | 59.7 |
| 1,4-BDDMA | 71.7 | — |
| TMPT | — | 33.0 |
| Irgacure 819 | 4.0 | — |
| Irgacure 127 | 1.0 | — |
| Darocur EDB | 1.0 | 1.0 |
| C.I. Pigment | — | 6.0 |
| BYK-UV3570 | 0.1 | 0.1 |
| Irgastab UV-10 | 0.2 | 0.2 |

TABLE 3

Example 2

| | Ink Composition A5 | Ink Composition B9 |
|---|---|---|
| | (%) | (%) |
| AG | 75.6 | 79.6 |
| STAR-501 | 15.0 | 13.0 |
| Irgacure 819 | 6.4 | — |
| Irgacure 369 | 1.6 | — |
| Darocur EDB | 1.0 | 1.0 |
| C.I. Pigment Bk7 | — | 6.0 |
| BYK-UV3570 | 0.2 | 0.2 |
| Irgastab UV-10 | 0.2 | 0.2 |

TABLE 4

| | Example 3 | |
|---|---|---|
| | Ink Composition A14 | Ink Composition B14 |
| | (%) | (%) |
| AG | 70.6 | 72.6 |
| Viscoat #1000 | 20 | 20 |
| Irgacure 819 | 6.4 | — |
| Irgacure 369 | 1.6 | — |
| Darocur EDB | 1 | 1 |
| C.I. Pigment Bk7 | — | 6 |
| BYK-UV3570 | 0.2 | 0.2 |
| Irgastab UV-10 | 0.2 | 0.2 |

TABLE 5

| | Example 4 | | Example 5 | | Example 6 | |
|---|---|---|---|---|---|---|
| | Ink | Ink | Ink | Ink | Ink | Ink |
| | Composition | Composition | Composition | Composition | Composition | Composition |
| | A7 (%) | B11 (%) | A1 (%) | B11 (%) | A7 (%) | B1 (%) |
| NVF | 20.0 | 20.0 | 25.0 | 20.0 | 20.0 | 25.0 |
| AG | 62.3 | 57.7 | 62.3 | 57.7 | 62.3 | 57.7 |
| STAR-501 | 6.6 | 13.2 | 6.6 | 13.2 | 6.6 | 13.2 |
| Irgacure 819 | 4.0 | — | 4.0 | — | 4.0 | — |
| Irgacure 369 | 1.0 | — | 1.0 | — | 1.0 | — |
| Darocur EHA | 1.0 | 1.0 | 1.0 | 1.0 | 1.0 | 1.0 |
| C.I. Pigment | — | 3.0 | — | 3.0 | — | 3.0 |
| BYK-UV3570 | 0.1 | 0.1 | 0.1 | 0.1 | 0.1 | 0.1 |
| Irgastab UV-10 | 0.05 | 0.05 | 0.05 | 0.05 | 0.05 | 0.05 |
| Ion exchanged | 5.0 | 5.0 | — | 5.0 | 5.0 | — |
| water | | | | | | |

TABLE 6

| | Rate of change in | Rate of change in | Evaluation of | |
|---|---|---|---|---|
| | viscosity of ink | viscosity of ink | preservation | Evaluation of |
| | composition A (%) | composition B (%) | stability | curability |
| Example 2 | 1.4 | 2.0 | AAA | A |
| Example 1 | 1.9 | 2.3 | AAA | A |
| Example 3 | 4.5 | 2.8 | AA | C |
| Example 4 | 4.5 | 2.8 | AA | C |
| Example 5 | 4.5 | 2.8 | AA | C |
| Example 6 | 4.5 | 2.8 | AA | C |

TABLE 7

| | Example 7 | | Example 8 | | Example 9 | |
|---|---|---|---|---|---|---|
| | Ink | Ink | Ink | Ink | Ink | Ink |
| | Composition | Composition | Composition | Composition | Composition | Composition |
| | A1 (%) | B1 (%) | A2 (%) | B1 (%) | A1 (%) | B2 (%) |
| NVF | 25.0 | 25.0 | 75.0 | 25.0 | 25.0 | 77.7 |
| AG | 68.9 | 57.7 | 18.9 | 57.7 | 68.9 | 5.0 |
| TPGDA | — | — | — | — | — | 13.2 |
| STAR-501 | — | 13.2 | — | 13.2 | — | — |
| Irgacure 819 | 4.0 | — | 4.0 | — | 4.0 | — |
| Irgacure 369 | 1.0 | — | 1.0 | — | 1.0 | — |
| Darocur EHA | 1.0 | 1.0 | 1.0 | 1.0 | 1.0 | 1.0 |
| C.I. Pigment | — | 3.0 | — | 3.0 | — | 3.0 |
| Bk7 | | | | | | |
| BYK-UV3570 | 0.1 | 0.1 | 0.1 | 0.1 | 0.1 | 0.1 |
| Irgastab UV-10 | 0.05 | 0.05 | 0.05 | 0.05 | 0.05 | 0.05 |

TABLE 8

| | Example 10 | | Example 11 | | Example 12 | |
|---|---|---|---|---|---|---|
| | Ink | Ink | Ink | Ink | Ink | Ink |
| | Composition | Composition | Composition | Composition | Composition | Composition |
| | A2 (%) | B2 (%) | A3 (%) | B1 (%) | A3 (%) | B3 (%) |
| NVF | 75.0 | 77.7 | 25.0 | 25.0 | 25.0 | 25.0 |
| AG | 18.9 | 5.0 | — | 57.7 | — | — |
| TPGDA | — | — | 68.9 | — | 68.9 | 70.9 |
| STAR-501 | — | 13.2 | — | 13.2 | — | — |
| Irgacure 819 | 4.0 | — | 4.0 | — | 4.0 | — |
| Irgacure 369 | 1.0 | — | 1.0 | — | 1.0 | — |
| Darocur EHA | 1.0 | 1.0 | 1.0 | 1.0 | 1.0 | 1.0 |
| C.I. Pigment Bk7 | — | 3.0 | — | 3.0 | — | 3.0 |
| BYK-UV3570 | 0.1 | 0.1 | 0.1 | 0.1 | 0.1 | 0.1 |
| Irgastab UV-10 | 0.05 | 0.05 | 0.05 | 0.05 | 0.05 | 0.05 |

TABLE 9

| | Comparative Example 1 | | Comparative Example 2 | | Comparative Example 3 | |
|---|---|---|---|---|---|---|
| | Ink | Ink | Ink | Ink | Ink | Ink |
| | Composition | Composition | Composition | Composition | Composition | Composition |
| | A4(%) | B1(%) | A1(%) | B4(%) | A4(%) | B4 (%) |
| NVF | 25.0 | 25.0 | 25.0 | 25.0 | 25.0 | 25.0 |
| AG | 59.3 | 57.7 | 68.9 | 52.7 | 59.3 | 52.7 |
| STAR-501 | 6.6 | 13.2 | — | 13.2 | 6.6 | 13.2 |
| Irgacure 819 | 4.0 | — | 4.0 | 4.0 | 4.0 | 4.0 |
| Irgacure 369 | 1.0 | — | 1.0 | 1.0 | 1.0 | 1.0 |
| Darocur EHA | 1.0 | 1.0 | 1.0 | 1.0 | 1.0 | 1.0 |
| C.I. Pigment Bk7 | 3.0 | 3.0 | — | 3.0 | 3.0 | 3.0 |
| BYK-UV3570 | 0.1 | 0.1 | 0.1 | 0.1 | 0.1 | 0.1 |
| Irgastab UV-10 | 0.05 | 0.05 | 0.05 | 0.05 | 0.05 | 0.05 |

TABLE 10

| | Comparative | | | |
|---|---|---|---|---|
| | Example 4 | | Comparative Example 5 | |
| | Ink | Ink | Ink | Ink Com- |
| | Composition | Composition | Composition | position |
| | A4 (%) | B2 (%) | A2 (%) | B4 (%) |
| NVF | 25.0 | 77.7 | 75.0 | 25.0 |
| AG | 59.3 | 5.0 | 18.9 | 52.7 |
| STAR-501 | 6.6 | 13.2 | — | 13.2 |
| Irgacure 819 | 4.0 | — | 4.0 | 4.0 |
| Irgacure 369 | 1.0 | — | 1.0 | 1.0 |
| Darocur EHA | 1.0 | 1.0 | 1.0 | 1.0 |
| C.I. Pigment Bk7 | 3.0 | 3.0 | — | 3.0 |
| BYK-UV3570 | 0.1 | 0.1 | 0.1 | 0.1 |
| Irgastab UV-10 | 0.05 | 0.05 | 0.05 | 0.05 |

TABLE 11

| | Rate of change in | Rate of change in | Evaluation of | |
|---|---|---|---|---|
| | viscosity of ink | viscosity of ink | preservation | Evaluation of |
| | composition A (%) | composition B (%) | stability | curability |
| Example 7 | 4.9 | 2.8 | AA | A |
| Example 8 | 4.5 | 3.5 | AA | A |
| Example 9 | 4.9 | 3.5 | AA | A |
| Example 10 | 9.3 | 2.8 | A | B |
| Example 11 | 9.3 | 5.8 | A | B |
| Comparative | 16.7 | 2.8 | B | B |
| Example 1 | | | | |
| Comparative | 4.5 | 11.8 | B | A |
| Example 2 | | | | |
| Comparative | 16.7 | 11.8 | B | B |
| Example 3 | | | | |
| Comparative | 16.7 | 3.5 | B | C |
| Example 4 | | | | |
| Comparative | 4.9 | 11.8 | B | A |
| Example 5 | | | | |

TABLE 12

| | Example 13 | Example 14 | Example 15 | Example 16 |
|---|---|---|---|---|
| | Ink Composition | Ink Composition | Ink Composition | Ink Composition |
| | A8 (%) | A9 (%) | A10 (%) | A11 (%) |
| NVF | 22.0 | 22.0 | 22.0 | 22.0 |
| TPGDA | 71.6 | 71.8 | 71.6 | 71.3 |
| Irgacure 819 | 4.0 | 4.0 | 4.0 | 4.0 |
| Irgacure 127 | 1.0 | 1.0 | 1.0 | 1.0 |
| Darocur EHA | 1.0 | 1.0 | 1.0 | 1.0 |
| BYK-UV3570 | 0.2 | 0.2 | 0.2 | 0.2 |
| Irgastab UV-10 | 0.2 | — | — | — |
| p-Methoxyphenol | — | — | 0.2 | 0.5 |

Although, in Examples 13 to 16 of Table 12, only the ink compositions A are shown, the ink compositions B are arbitrary.

TABLE 13

| | Rate of change | | |
|---|---|---|---|
| | in viscosity of ink | Evaluation of | Evaluation |
| | composition A (%) | preservation stability | of curability |
| Example 13 | 10.0 | A | A |
| Example 14 | 38.9 | B | A |
| Example 15 | 84.2 | B | A |
| Example 16 | 31.6 | B | C |

TABLE 14

| | Example 17 | | Example 18 | | Example 19 | |
|---|---|---|---|---|---|---|
| | Ink | Ink | Ink | Ink | Ink | Ink |
| | Composition | Composition | Composition | Composition | Composition | Composition |
| | A12(%) | B12(%) | A12(%) | B9(%) | A5(%) | B12 (%) |
| AG | 75.6 | 79.6 | 75.6 | 79.6 | 75.6 | 79.6 |
| Dendrimer 7 | 15.0 | 13.0 | 15.0 | — | — | 13.0 |
| Dendrimer 9 | — | — | — | — | — | — |
| STAR-501 | — | — | — | 13.0 | 15.0 | — |
| Irgacure 819 | 6.4 | — | 6.4 | — | 6.4 | — |
| Irgacure 369 | 1.6 | — | 1.6 | — | 1.6 | |
| Darocur EDB | 1.0 | 1.0 | 1.0 | 1.0 | 1.0 | 1.0 |
| C.I. Pigment | — | 6.0 | — | 6.0 | — | 6.0 |
| Bk7 | | | | | | |
| BYK-UV3570 | 0.2 | 0.2 | 0.2 | 0.2 | 0.2 | 0.2 |
| Irgastab UV-10 | 0.2 | 0.2 | 0.2 | 0.2 | 0.2 | 0.2 |

TABLE 15

| | Example 20 | | Example 21 | | Example 22 | |
|---|---|---|---|---|---|---|
| | Ink | Ink | Ink | Ink | Ink | Ink |
| | Composition | Composition | Composition | Composition | Composition | Composition |
| | A13(%) | B13(%) | A12(%) | B13(%) | A13(%) | B12 (%) |
| AG | 75.6 | 79.6 | 75.6 | 79.6 | 75.6 | 79.6 |
| Dendrimer 7 | — | — | 15.0 | — | — | 13.0 |
| Dendrimer 9 | 15.0 | 13.0 | — | 13.0 | 15.0 | — |
| STAR-501 | — | — | — | — | — | — |
| Irgacure 819 | 6.4 | — | 6.4 | — | 6.4 | — |
| Irgacure 369 | 1.6 | — | 1.6 | — | 1.6 | |
| Darocur EDB | 1.0 | 1.0 | 1.0 | 1.0 | 1.0 | 1.0 |
| C.I. Pigment | — | 6.0 | — | 6.0 | — | 6.0 |
| Bk7 | | | | | | |
| BYK-UV3570 | 0.2 | 0.2 | 0.2 | 0.2 | 0.2 | 0.2 |
| Irgastab UV-10 | 0.2 | 0.2 | 0.2 | 0.2 | 0.2 | 0.2 |

TABLE 16

| | Rate of change in | | Evaluation of | Evaluation |
|---|---|---|---|---|
| | viscosity of ink | Rate of change in viscosity | preservation | of |
| | composition A (%) | of ink composition B (%) | stability | curability |
| Example 17 | 1.6 | 1.9 | AAA | A |
| Example 18 | 1.6 | 2.0 | AAA | A |
| Example 19 | 1.4 | 1.9 | AAA | A |
| Example 20 | 0.0 | 0.0 | AAA | B |
| Example 21 | 1.6 | 0.0 | AAA | B |
| Example 22 | 0.0 | 1.9 | AAA | B |

Table 6 indicates that when the ink composition contains water, curability is low.

Table 11 indicates that when the ink composition A contains the colorant or when the ink composition B contains the photoradical polymerization initiator, preservation stability is low.

Table 13 indicates that when the thermal radical polymerization inhibitor contained in the ink composition is a HALS compound, the ink composition has excellent preservation stability.

Table 16 indicates that an ink containing the dendrimer 7 having radically polymerizable functional groups in the outer surface thereof has excellent curability as compared with an ink containing the dendrimer 9 not having radically polymerizable functional groups in the outer surface thereof.

### (Curability Test 2)

Each of the color ink composition sets shown in Table 17 was used in full-color image printing. The ink composition A1 was used as the ink composition A, and each of the ink compositions B1 and B5 to B8 containing different types of colorants was used as the ink composition B. The full-color image printing was performed at normal temperature and normal pressure using an ink jet printer PM-G920 manufactured by Seiko Epson Corporation in which color inks containing the ink composition B1 and B5 to B7 were charged in respective corresponding color lines, the ink composition A1 was charged in a gross optimizer line, and the ink composition B8 was charged in a mat black line under a printing condition in which color ink droplets were ejected to corresponding positions, and the ink composition A1 was ejected to cover the entire image region. As a recording medium, an A4-size OHP film (manufactured by Fuji Xerox Co., Ltd., XEROX FILM (marginless)) was used. Printing and curing were performed using the above-described ultraviolet irradiation light source installed at a paper ejection port under a curing condition in which the integrated quantity of light was 600 mJ/cm². It was confirmed that a cured film of a full-color image was obtained.

TABLE 17

| | Example 23 | | | | | |
|---|---|---|---|---|---|---|
| | Ink | Ink | Ink | Ink | Ink | Ink |
| | Composition | Composition | Composition | Composition | Composition | Composition |
| | A1(%) | B1(%) | B5(%) | B6(%) | B7(%) | B8 (%) |
| NVF | 25.06 | 25.0 | 25.0 | 25.0 | 25.0 | 25.0 |
| AG | 62.3 | 57.7 | 57.7 | 57.7 | 57.7 | 57.7 |
| STAR-501 | 6.6 | 13.2 | 13.2 | 13.2 | 13.2 | 13.2 |
| Irgacure 819 | 4.0 | — | — | — | — | — |
| Irgacure 369 | 1.0 | — | — | — | — | — |
| Darocur EDB | 1.0 | 1.0 | 1.0 | 1.0 | 1.0 | 1.0 |
| Pigment | — | PBk7 | PY151 | PV19 | PB15:3 | PW6 |
| | | 30 | 3.0 | 3.0 | 3.0 | 3.0 |
| BYK-UV3570 | 0.1 | 0.1 | 0.1 | 0.1 | 0.1 | 0.1 |
| Irgastab UV-10 | 0.05 | 0.05 | 0.05 | 0.05 | 0.05 | 0.05 |

In addition, it was confirmed that when the transparent recording medium is pre-treated with the ink composition A1 and the ink composition B8 (white ink) before image formation, the back of the recording medium is not seen through. Further, when the image formed on the transparent medium is treated after image formation, backlight printing becomes possible, in which the back is not seen through.

These results reveal that the ink composition A and the ink composition B of the two-part photocurable ink composition set of each of the examples of the invention produce satisfactory results in curability and preservation stability evaluation and are thus sufficiently usable.

1. A two-part photocurable ink composition set comprising:
an ink composition A containing at least a photoradical polymerization initiator and a radically polymerizable compound and not containing a colorant; and
an ink composition B containing at least a colorant and a radically polymerizable compound and not containing a photoradical polymerization initiator.

2. The two-part photocurable ink composition set according to claim 1, wherein the ink composition A and the ink composition B do not contain water.

3. The two-part photocurable ink composition set according to claim 1, wherein an ethylene glycol monoallyl ether and/or a N-vinyl compound is contained as the radically polymerizable compound of the ink composition A and/or the ink composition B.

4. The two-part photocurable ink composition set according to claim 3, wherein the amount of the ethylene glycol monoallyl ether and/or the N-vinyl compound contained in the ink composition A and/or the ink composition B is in the range of 20% by weight to 80% by weight.

5. The two-part photocurable ink composition set according to claim 3, wherein the N-vinyl compound is N-vinyl formamide.

6. The two-part photocurable ink composition set according to claim 1, wherein a dendritic polymer is contained as the radically polymerizable compound in the ink composition A and/or the ink composition B.

7. The two-part photocurable ink composition set according to claim 6, wherein the dendritic polymer is a dendrimer and/or a hyperbranched polymer.

8. The two-part photocurable ink composition set according to claim 6, wherein the content of the dendritic polymer is 3 to 30% by weight.

9. The two-part photocurable ink composition set according to claim 1, wherein the ink composition A and/or the ink composition B contains a surfactant.

10. The two-part photocurable ink composition set according to claim 9, wherein a polyether-modified polydimethylsiloxane or a polyester-modified polydimethylsiloxane is used as the surfactant.

11. The two-part photocurable ink composition set according to claim 1, wherein the ink composition A and/or the ink composition B contains a polymerization accelerator.

12. The two-part photocurable ink composition set according to claim 1, wherein any one of an amine compound, thioxanthone, and polymerizable fine particles is contained as the polymerization accelerator.

13. The two-part photocurable ink composition set according to claim 1, wherein the photoradical polymerization initiator contained in the ink composition A is any one of α-aminoketone, α-hydroxyketone, and acylphosphine oxide.

14. The two-part photocurable ink composition set according to claim 13, wherein a mixture of any two or more of α-aminoketone, α-hydroxyketone, and acylphosphine oxide is used as the photoradical polymerization initiator.

15. The two-part photocurable ink composition set according to claim 1, wherein the ink composition A and the ink composition B contain a thermal radical polymerization inhibitor.

16. The two-part photocurable ink composition set according to claim 15, wherein the thermal radical polymerization inhibitor is a HALS compound.

17. The two-part photocurable ink composition set according to claim 1, wherein the colorant contained in the ink composition B is a pigment.

18. An ink jet recording method using the two-part photocurable ink composition set according to claim 1.

19. An ink jet recording apparatus using the ink jet recording method according to claim 18.

20. A print comprising an image at least a portion of which is formed using the ink jet recording method according to claim 18.

21. A print comprising an image at least a portion of which is formed using the ink jet recording apparatus according to claim 19.
